(19) United States
(12) Patent Application Publication
(10) Pub. No.: US 2015/0137698 A1
(43) Pub. Date: May 21, 2015

(54) METHOD AND APPARATUS FOR INTEGRATED LIGHTING CONTROL ACCORDING TO POWER RESERVE STAGE

(71) Applicant: Electronics and Telecommunications Research Institute, Daejeon (KR)

(72) Inventors: Myung-Soon KIM, Daejeon (KR); Tae-Gyu KANG, Daejeon (KR); Sang-Kyu LIM, Daejeon (KR); Il-Soon JANG, Daejeon (KR); Jin-Doo JEONG, Daejeon (KR)

(21) Appl. No.: 14/517,744

(22) Filed: Oct. 17, 2014

(30) Foreign Application Priority Data
Nov. 15, 2013 (KR) 10-2013-0139012

(51) Int. Cl. H05B 33/08; H05B 37/02

(52) U.S. Cl. CPC H05B 33/0848; H05B 37/0245
USPC 315/291

(57) ABSTRACT

Disclosed is a method and apparatus for integrally controlling lighting according to the status of power reserve stages. The apparatus for integrally controlling lighting according to power reserve stage, comprises: a lighting control result receiver for receiving lighting control result data generated by integrating a lighting identification number and control result information of the LED light source the brightness of which is controlled according to power reserve stage-based lighting control information; a power reserve stage determination unit for determining a power reserve stage based on the received lighting control result data; and a power reserve stage issuer for transmitting the determined power reserve stage to the lighting controller in real time.

### CROSS REFERENCE TO RELATED APPLICATION

This application claims the benefit of Korean Patent Application No. 10-2013-0139012, filed on Nov. 15,2013, which is hereby incorporated by reference in its entirety into this application.

### BACKGROUND OF THE INVENTION

1. Technical Field

The present invention relates generally to an integrated lighting control system which depends upon power reserve stage and, more particularly, to an integrated lighting control technology which enables integrated control of lighting by reflecting power supply status information in order to control lighting power demands accordingly and monitoring the controlled results in real time.

2. Description of the Related Art

The Republic of Korea has a power reserve scale divided into 5 stages in order to prevent incidents such as power blackouts, etc. Usually, the power reserve, when exceeding 5 million kW, is considered as being in a stable stage while an emergency alert is issued when the power reserve falls below 5 million kW. In detail, the emergency alert is classified according to the power reserve level: a preparation stage at 4˜5 million kW, an attention stage at 3˜4 million kW, a caution stage at 2˜3 million kW, an alert stage at 1˜2 million kW, and an urgency stage at less than 1 million kW, with action guidelines for each stage supplied for the government, corporations, and the general population.

As such, the power demand management system finally aims to stabilize electricity supply and demand by fairly diverting daytime peak demand in the summer, a season where there is a lot of transient power usage, towards demand at a midnight time slot so as to achieve an electricity load balance, and by improving capacity factors, with the consequent reduction or delay of a demand and investment for electricity sources. As used herein, the term “electricity load balance” refers to a reduction in difference between maximum and minimum loads of the entire power usage. Load management for load balancing includes a maximum demand suppression program and a maximum demand transition program. The maximum demand suppression program is structured so as to suppress the maximum demand by seasons or time slots, and includes a load control charge support system, direct load control, remote air-conditioner control, and a provision of a maximum power management device, etc. The maximum power transition program is configured to transfer power demand during peak hours to light load hours so as to reduce the maximum demand during daytime peaks and increase loads at midnight, and includes the program of, for example, spreading cold storage type cooling equipment.

As described above, there have been increasing demands for measures for achieving the final target of power demand management and preventing enormous economic loss due to the occurrence of blackouts, and thus increasing demands for a method and an apparatus for controlling lighting according to the power reserve state and for resolving inefficient power problems attributed to power demand forecast errors.

A related art may be found in Korean Patent Application Publication No. 2013-0005769, which discloses a smart lighting control method.

### SUMMARY OF THE INVENTION

An object of the present invention is to efficiently control electric power used for lighting according to power reserve stages by providing lighting controllers with information on the power reserve stages.

Another object of the present invention is to enable effective power reserve stage control and power demand forecasting by providing power reserve stage information in real time and receiving information on lighting control according to the power reserve stages so as to enable an integrated control of lighting.

A further object of the present invention is to provide highly accurate power demand forecasting by enabling active control with prior equipment settings, according to the power reserve stages, rather than allowing users or individual control systems to control lighting.

In accordance with an aspect of the present invention to accomplish the above object, there is provided an apparatus for integrated lighting control according to power reserve stage, comprising: a lighting control result receiver for receiving lighting control result data generated by integrating a lighting identification number and control result information of the LED light source the brightness of which is controlled according to power reserve stage-based lighting control information; a power reserve stage determination unit for determining a power reserve stage based on the received lighting control result data; and a power reserve stage issuer for transmitting information on the determined power reserve stage to lighting controller in real time.

The power reserve stage issuer may transmit the information on the power reserve stage every minimum allowable time span if the power reserve stage is lower than an alert stage, every medium allowable time span if the power reserve stage is between the alert stage and a stable stage, and every maximum allowable time span if the power reserve stage is higher than the stable stage.

The lighting control result data may include information on a control result transmission location, control result received time, and a control result value.

The lighting control result receiver compares the control result received time with the current time either to check the lighting control result data if the control result received time and the current time are same, or to ignore the lighting control result data if the control result received time and the current time are not same.

The lighting control result database may store and manage the lighting control result data.

The power reserve stage determination unit calculates variation of the control result value by checking a previous control result value received from the control result transmission location, and determines the power reserve stage based on the variation.

In accordance with another aspect thereof, the present invention provides a power reserve stage-based lighting controller, comprising: a power reserve stage receiver for receiving, in real time, information on the power reserve stage issued from an integrated lighting control apparatus; a lighting soft switch unit for controlling brightness of an LED light source according to lighting control information corresponding to the information on the power reserve stage; an LED lighting unit for transmitting a lighting identification number and control result information using the controlled brightness LED light source; and a lighting control result transceiver for receiving the lighting identification number and control result information, integrating the lighting identification number and control result information to generate lighting control result data, and transmitting the lighting control result data to the integrated lighting control apparatus.

The lighting controller may perform lighting dimming control of the LED light source using the lighting soft switch unit if the power reserve stage is lower than an alert stage, and may apply standby power to the lighting soft switch unit to prepare for a case where the power reserve stage becomes lower if the power reserve stage is in between the alert stage and a stable stage.

The lighting control result transceiver transmits lighting dimming control information of the LED light source, in line with the lighting control result data, to the integrated lighting control apparatus if the power reserve stage is lower than the alert stage.

The lighting controller may not apply standby power to the lighting soft switch unit if the power reserve stage is equal or higher than the stable stage.

In accordance with a further aspect thereof, the present invention provides a method for integrated lighting control according to power reserve stage, comprising: receiving lighting control result data generated by integrating a lighting identification number and control result information of an LED light source the brightness of which is controlled according to power reserve stage-based lighting control information; determining a power reserve stage based on the received lighting control result data; and transmitting information on the determined power reserve stage to the lighting controller in real time.

The transmitting may comprise transmitting the information on the power reserve stage every minimum allowable time span if the power reserve stage is lower than an alert stage, every medium allowable time span if the power reserve stage is between the alert stage and a stable stage, and every maximum allowable time span if the power reserve stage is higher than the stable stage.

The lighting control result data may include information on a control result transmission location, control result received time, and a control result value.

The receiving may comprise comparing the control result received time with a current time either to check the lighting control result data if the control result received time and the current time are same, or to ignore the lighting control result data if the control result received time and the current time are not same.

The method may further comprises storing and managing the lighting control result data.

The determining may comprise calculating variation of the control result value by checking the previous control result value received from the control result transmission location, and determining the power reserve stages based on the variation.

The method may further comprises receiving, by the lighting controller, the information on the power reserve stage in real time to control brightness of a LED light source according to lighting control information corresponding to the information on the power reserve stage and transmitting, by the lighting controller, the lighting control result data generated by integrating the lighting identification number and the control result information received from the LED light source to the integrated lighting control apparatus.

The method may further comprises performing, by the lighting controller, lighting dimming control of the LED light source using the lighting soft switch unit if the power reserve stage is lower than the alert stage and applying, by the lighting controller, standby power to the lighting soft switch unit to prepare for a case where the power reserve stage becomes lower if the power reserve stage is in between the alert stage and the stable stage.

The method may further comprises transmitting, by the lighting controller, in line with the lighting control result data, lighting dimming control information of the LED light source to the integrated lighting control apparatus if the power reserve stage is lower than the alert stage.

The method may further comprises not applying, by the lighting controller, standby power to the lighting soft switch unit if the power reserve stage is equal or higher than the stable stage.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating an integrated lighting control system according to the power reserve stages in accordance with an embodiment of the present invention;

FIG. 2 is a block diagram illustrating an integrated lighting control apparatus in accordance with an embodiment of the present invention;

FIG. 3 is a block diagram illustrating a lighting controller in accordance with an embodiment of the present invention;

FIG. 4 is an operation flow chart illustrating an integrated lighting control method in accordance with an embodiment of the present invention;

FIG. 5 is an operation flow chart illustrating an operation method of a lighting controller in accordance with an embodiment of the present invention;

FIG. 6 is an operation flow chart illustrating a method of issuing power reserve stages in accordance with an embodiment of the present invention;

FIG. 7 is an operation flow chart illustrating a power reserve stage-based lighting control method in accordance with an embodiment of the present invention;

FIG. 8 is an operation flow chart illustrating a method to process lighting control result data in accordance with an embodiment of the present invention;

FIG. 9 is a drawing illustrating lighting control result data in accordance with an embodiment of the present invention; and

FIG. 10 is a drawing illustrating a lighting control result database in accordance with an embodiment of the present invention.

### DESCRIPTION OF THE PREFERRED EMBODIMENTS

Embodiments of the present invention will be described in detail with reference to the accompanying drawings. Hereinafter, a detailed description of a notification function and configuration that may unnecessarily make the purport of the present invention ambiguous will be omitted. Embodiments of the present invention are provided to those with average knowledge in this industry for more complete description of the present invention. Therefore, shapes, sizes, etc. of elements in drawings may be exaggerated for clearer description.

Hereinafter, preferred embodiments in accordance with the present invention will be described in detail with reference to the accompanying drawings.

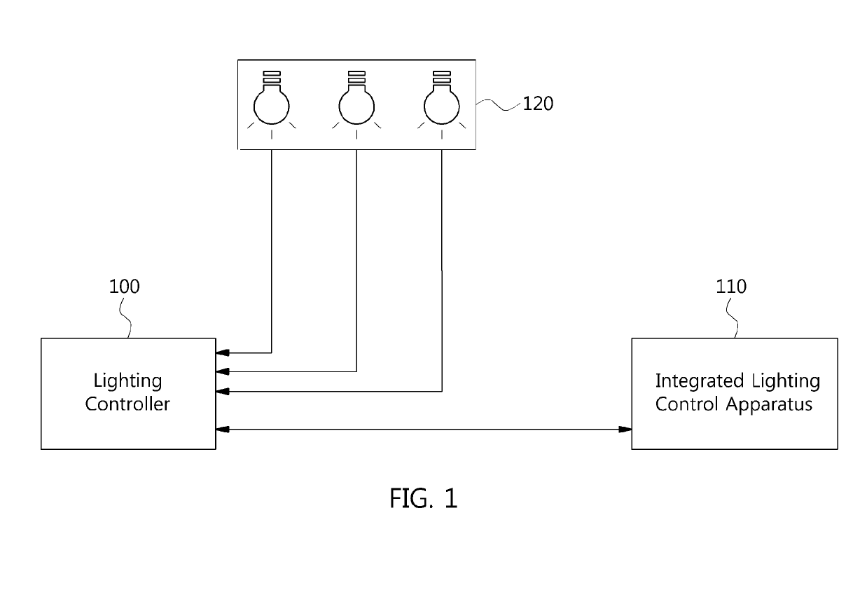

FIG. 1 is a view illustrating an integrated lighting control system by power reserve stage in accordance with an embodiment of the present invention.

With reference to FIG. 1, the integrated lighting control system by power reserve stages in accordance with an embodiment of the present invention comprises a lighting controller 100, an integrated lighting control apparatus 110, and lighting equipment 120.

The lighting controller 100 is composed of a power reserve stage receiver for receiving, in real time, power reserve stage information issued from the integrated lighting control apparatus 110, a lighting soft switch unit for controlling brightness of LED light sources according to the power reserve stage-based lighting control information, an LED lighting unit for transmitting a lighting identification number and control result information using the controlled brightness LED light source, and a lighting control result transceiver for receiving the lighting identification number and control result information, integrating the lighting identification number and control result information to generate light control result data, and transmitting the lighting control result data to the integrated lighting control apparatus 110.

The integrated lighting control apparatus 110 comprises a lighting control result receiver for receiving the lighting control result data generated by integrating the lighting identification number and control result information of the LED light source the brightness of which is controlled according to the power reserve stage-based lighting control information, a power reserve stage determination unit for determining a power reserve stage based on the received lighting control result data, and a power reserve stage issuer for transmitting the determined power reserve stages to the lighting controller 100 in real time.

Reflecting the brightness controlled by the lighting controller 100, the lighting equipment 120 transmits the lighting identification number and control result information included in the LED light to the lighting control result transceiver.

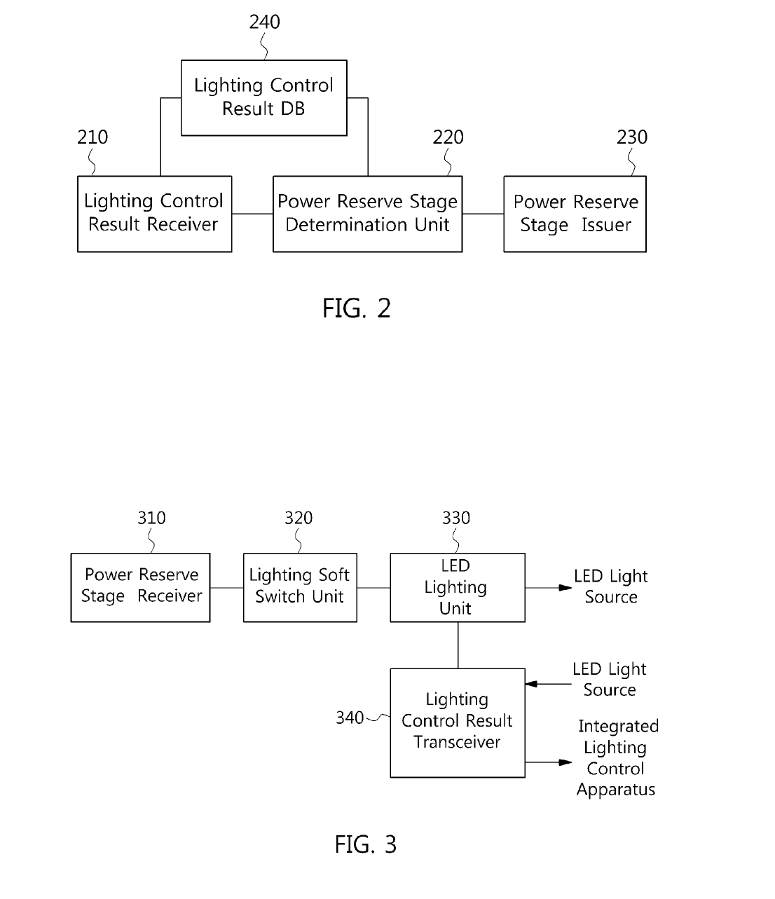

FIG. 2 is a block diagram illustrating an integrated lighting control apparatus in accordance with an embodiment of the present invention.

With reference to FIG. 2, the integrated lighting control apparatus in accordance with an embodiment of the present invention is composed of a lighting control result receiver 210 for receiving the lighting control result data, a power reserve stage determination unit 220 for determining a power reserve stage, a power reserve stage issuer 230 for transmitting the power reserve stage to the lighting controller, and a lighting control result database 240 for storing lighting control result data.

The lighting control result receiver 210 may receive the lighting control result data generated by integrating the lighting identification number and control result information of the controlled brightness LED light source, the brightness of which is controlled according to the power reserve stage-based lighting control information. In this regard, the lighting control result data may include information on, for example: a control result transmission location, control result receiving time, a control result value, etc. In addition, the lighting control result receiver 210 can compare the control result received time with the current time to confirm the lighting control result data if the control result received time and the current time are the same, or ignore the lighting control result data if the control result received time and the current time are not same.

The power reserve stage determination unit 220 can determine a power reserve stage based on the received lighting control result data. For this, the power reserve stage determination unit 220 can calculate variation of control result values by checking a previous control result value received from the control result transmission location using the lighting control result database 240, and can determine a power reserve stage based on the variation.

The power reserve stage issuer 230 can transmit information on the determined power reserve stage to the lighting controller in real time. In this regard, the power reserve stage issuer may transmit the power reserve stage information every minimum allowable time span if the power reserve stage is lower than alert, every medium allowable time span if the power reserve stage above is between alert and stable stages, and every maximum allowable time span if the power reserve stage is higher than a stable stage. Usually, the power reserve, when exceeding 5 million kW, is considered as being in a stable stage while an emergency alert is issued when the power reserve is below 5 million kW. In detail, the emergency alert is classified according to the power reserve: a preparation stage at 4˜5 million kW, an attention stage at 3˜4 million kW, a caution state at 2˜3 million kW, an alert stage at 1˜2 million kW, and an urgency stage at less than 1 million kW, with action guideline for each stage supplied for the government, corporations, and the general public.

The lighting control result database 240 stores and manages the lighting control result data and can store the current and previous control result values according to the control result transmission location, and the variation of the control result value.

FIG. 3 is a block diagram illustrating a lighting controller in accordance with an embodiment of the present invention.

With reference to FIG. 3, the lighting controller in accordance with an embodiment of the present invention is composed of a power reserve stage receiver 310 for receiving power reserve stage information, a lighting soft switch unit 320 for controlling brightness of LED light sources, and an LED lighting unit 330 for sending a lighting identification number and a control result number, and a lighting control result transceiver 340 for generating and transmitting lighting control result data to the integrated lighting control apparatus.

The power reserve stage receiver 310 can receive power reserve stage information issued from the integrated lighting control apparatus.

The lighting soft switch unit 320 can control brightness of the LED light source according to the lighting control information based on the power reserve stage.

The LED lighting unit 330 can send the lighting identification number and the control result information using the controlled brightness LED light source.

The lighting control result transceiver 340 can receive and integrate the lighting identification number and the control result information to generate the lighting control result data, and can transmit the lighting control result data to the integrated lighting control apparatus. In this context, the lighting control result transceiver can transmit, in line with the lighting control result, lighting dimming control information of the LED light source to the integrated lighting control apparatus if the power reserve stage is lower than alert stage.

In addition, the lighting controller can perform lighting dimming control of the LED light source through the lighting soft switch unit 320 if the power reserve stage is lower than alert stage, and can apply standby power to the lighting soft switch unit 320 to prepare for a case when the power reserve stage becomes lower if the power reserve stage is in between alert and stable stages. Usually, the power reserve, when exceeding 5 million kW, is considered as being in a stable stage while an emergency alert is issued when the power reserve is below 5 million kW. In detail, the emergency alert is classified according to the power reserve: a preparation stage at 4˜5 million kW, an attention stage at 3˜4 million kW, a caution state at 2˜3 million kW, an alert stage at 1˜2 million kW, and an urgency stage at less than 1 million kW, with action guideline for each stage supplied for the government, corporations, and the general public.

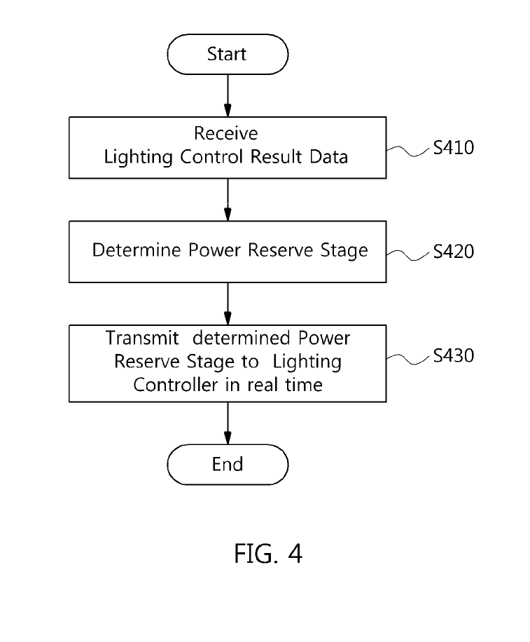

FIG. 4 is an operation flow chart illustrating an integrated lighting control method in accordance with an embodiment of the present invention.

With reference to FIG. 4, the integrated lighting control method in accordance with an embodiment of the present invention starts with receiving the lighting control result data (S410). First, the lighting control result data generated by integrating the lighting identification number and control result information of the LED light source the brightness of which is controlled according to the power reserve stage-based lighting control information is received. In this context, the lighting control result data may include information on, for example, a control result transmission location, control result received time, a control result value, etc. In addition, the control result received time is compared with the current time either to check the lighting control result data if the control result received time and the current time are same, or to ignore the lighting control result data if the control result received time and the current time are not same.

In the integrated lighting control method in accordance with an embodiment of the present invention, the next step is to determine a power reserve stage based on the received lighting control result data (S420). For this, variation of control result values is calculated by checking a previous control result value received from the control result transmission location using the lighting control result database 240, and the power reserve stage is determined based on the variation.

The integrated lighting control method in accordance with an embodiment of the present invention can transmit information on the determined power reserve stage to the lighting controller in real time (S430). In this case, lighting controller receives the power reserve stage information in real time, control the brightness of an LED light source according to the power reserve stage-based lighting control information, integrates lighting identification number and control result information received from the controlled LED light source to generate light control result data, and transmit the light control result data to the integrated lighting control apparatus. In addition, the lighting controller can dim the lighting of the LED light source in a controlled manner through the lighting soft switch unit if the power reserve stage is lower than alert stage, and can apply standby power to the lighting soft switch unit to prepare for a case when the power reserve stage becomes lower if the power reserve stage is in between alert and stable stages. Further, the lighting controller can transmit lighting dimming control information of the LED light source in line with the lighting control result data to the integrated lighting control apparatus if the power reserve stage is lower than alert stage. Usually, the power reserve, when exceeding 5 million kW, is considered as being in a stable stage while an emergency alert is issued when the power reserve is below 5 million kW. In detail, the emergency alert is classified according to the power reserve: a preparation stage at 4˜5 million kW, an attention stage at 3˜4 million kW, a caution state at 2˜3 million kW, an alert stage at 1˜2 million kW, and an urgency stage at less than 1 million kW, with action guideline for each stage supplied for the government, corporations, and the general public.

In addition, the integrated lighting control method can store and manage the lighting control result data.

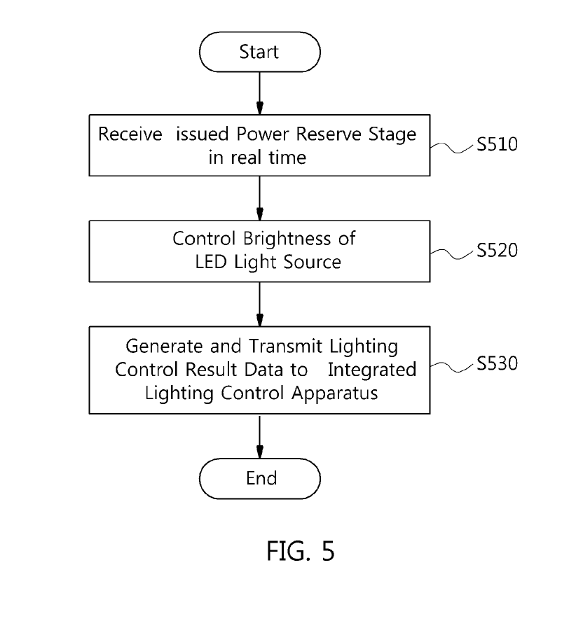

FIG. 5 is an operation flow chart illustrating an operation method of a lighting controller in accordance with an embodiment of the present invention.

With reference to FIG. 5, the operation method of the lighting controller in accordance with an embodiment of the present invention starts with receiving the power reserve stage information issued previously in real time (S510).

In the next step, the brightness of an LED light source is controlled according to the power reserve stage-based lighting control information (S520). In this regard, the light controller can perform lighting dimming control of the LED light source in a controlled manner through the lighting soft switch unit if the power reserve stage is lower than alert stage, and can apply standby power to the lighting soft switch unit to prepare for a case where the power reserve stage becomes lower if the power reserve stage is in between alert and stable stages. Subsequently, the lighting controller transmits lighting dimming control information of the LED light source, in line with the lighting control result data, to the integrated lighting control apparatus if the power reserve stage is lower than an alert stage. Usually, the power reserve, when exceeding 5 million kW, is considered as being in a stable stage while an emergency alert is issued when the power reserve is below 5 million kW. In detail, the emergency alert is classified according to the power reserve: a preparation stage at 4˜5 million kW, an attention stage at 3˜4 million kW, a caution state at 2˜3 million kW, an alert stage at 1˜2 million kW, and an urgency stage at less than 1 million kW, with action guideline for each stage supplied for the government, corporations, and the general public.

Afterwards, the lighting identification number and the control result information received from the controlled LED light source are integrated to generate lighting control result data which is then transmitted to the integrated lighting control apparatus (S530).

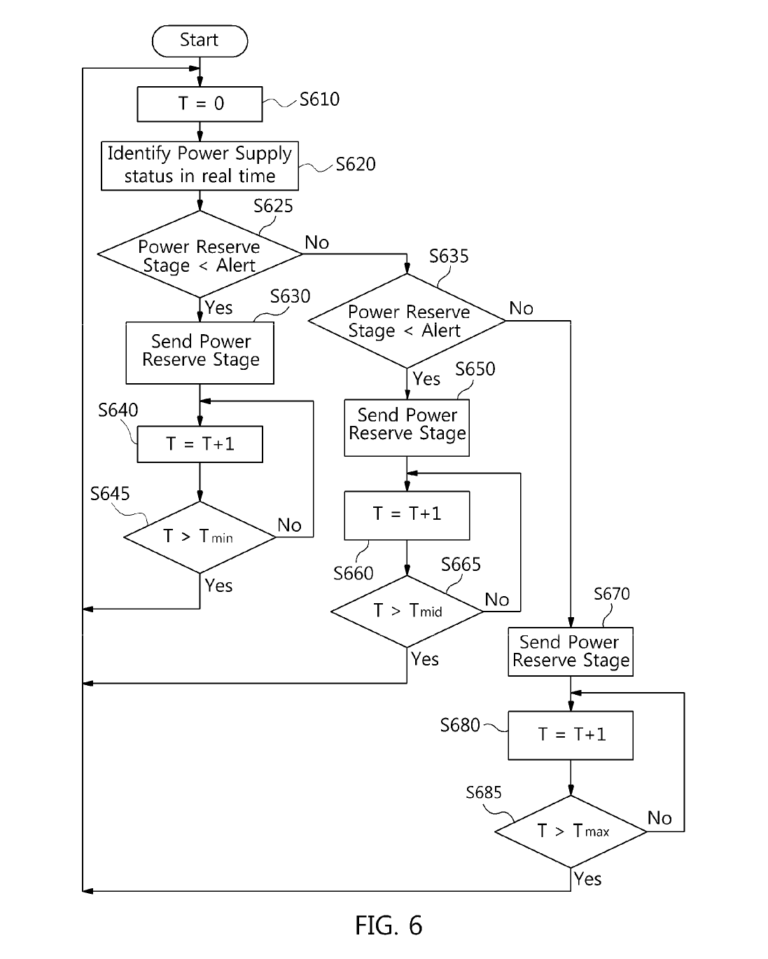

FIG. 6 is an operation flow chart illustrating a method for issuing a power reserve stage information in accordance with an embodiment of the present invention.

With reference to FIG. 6, the power reserve status issuing method in accordance with an embodiment of the present invention starts with setting a time interval unit (T) as 0 (S610).

Afterwards, a power supply status is identified in real time (S620). The power supply status may be identified in a way that the lighting controller receives the lighting control result data generated by integrating the lighting identification number and the control result information of the controlled brightness LED light source in real time.

Then, the power supply statuses s identified at Step (S620) is used to determine if the power reserve stage is lower than the alert stage (S625). Usually, the power reserve, when exceeding 5 million kW, is considered as being in a stable stage while an emergency alert is issued when the power reserve is below 5 million kW. In detail, the emergency alert is classified according to the power reserve: a preparation stage at 4˜5 million kW, an attention stage at 3˜4 million kW, a caution state at 2˜3 million kW, an alert stage at 1˜2 million kW, and an urgency stage at less than 1 million kW, with action guideline for each stage supplied for the government, corporations, and the general public.

As a result of comparison at Step (S625), if the power reserve stage is lower than the alert stage, the power reserve stage information is transmitted to the lighting controller (S630), and the time interval unit (T) increases by 1 (S640).

If the time interval unit (T) is determined to be lower than the minimum allowable time span by comparison (S645), Step (S640) may be repeated until the time interval unit (T) becomes larger than the minimum allowable time span.

As a result of comparison at Step (S625), if the power reserve stage is higher than the alert stage, measurement is made to see if the power reserve stage is lower than the stable stage (S635).

If the result of Step (S635) shows that the power reserve stage is lower than the stable stage, the power reserve stage information is transmitted to the lighting controller (S650), and the time interval unit (T) increases by 1 (S660).

If the time interval unit (T) is lower than the medium allowable time span by comparison (S665), Step (S660) is repeated until the time interval unit (T) becomes larger than the medium allowable time span.

When the comparison of Step (S635) indicates that the power reserve stage is higher than the stable stage, the power reserve stage information is transmitted to lighting controller (S670), and the time interval unit (T) increases by 1 (S680).

If the time interval unit (T) is determined to be lower than the maximum allowable time span by comparison (S685), Step (S680) is repeated until the time interval unit (T) becomes larger than the maximum allowable time span.

As mentioned above, the time interval unit at which the power reserve stage information is transmitted to the lighting controller is set different according to the power reserve stage, so that the power reserve stage information is more frequently transmitted for lower power reserve stages, whereby the lighting can be controlled in a more rapid manner.

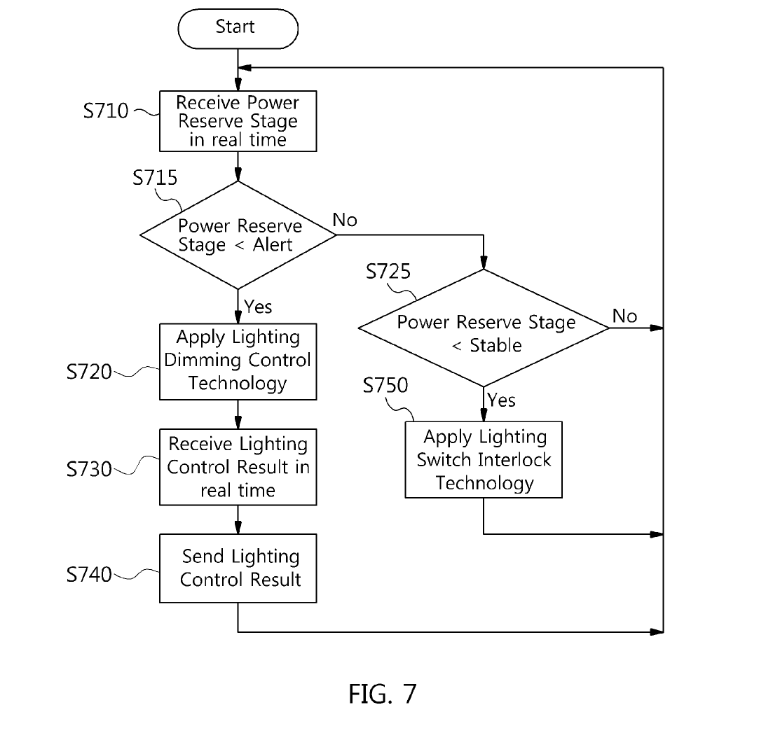

FIG. 7 is an operation flow chart illustrating a method for controlling lighting according to the power reserve stage in accordance with an embodiment of the present invention.

With reference to FIG. 7, the power reserve stage-based lighting control method in accordance with an embodiment of the present invention starts with receiving the power reserve stage information from the lighting controller in real time (S710).

Afterwards, comparison is made to see the received power reserve stage is lower than the alert stage (S715).

When the comparison at Step (S715) indicates that the power reserve stage is lower than the alert stage, lighting dimming control technology is applied to the lighting controller (S720). The lighting dimming control technology is to adjust brightness of LED lighting, which may be achieved mainly by two methods: one is to change a magnitude of voltage or current applied to the LED light source through an analog circuit, and the other is a PWM (Pulse Width Modulation) method for adjusting time when the LED light source turns on along the time axis with digital control. According to the principle of the PWM method for adjusting brightness, the longer the time span the LED light source turns on per a unit time (T), the brighter the LED light source becomes. Electric power (P) refers to a ratio that electric energy is converted to the other energy, i.e. multiplication of voltage and current (P=VI). Therefore, electric power may increase in proportion to the time span when the LED light source is turned on. On the contrary, the shorter the time span the LED light source is turned on, the darker the LED light source becomes, so that power consumption may be proportionally reduced.

The lighting controller can receive lighting control results obtained by the lighting dimming control technology of Step (S720) in real time (S730).

Next, the received lighting control result is transmitted to the integrated lighting control apparatus (S740).

If the power reserve stage is determined to be higher than the alert stage by the comparison at Step (S715), comparison is made to see if the power reserve stage is lower than the stable stage (S725).

When the comparison of Step (S725) indicates that the power reserve stage is lower than the stable stage, a lighting switch interlocking technology is applied to the lighting controller (S750). The lighting switch interlocking technology refers to a technology for applying standby power for automatic control of the lighting switch against the case where the power reserve stage becomes lower than the current stage.

When the comparison of Step (S725) indicates that the power reserve stage is equal or higher than the stable stage, it may operate so that standby power is not applied to the circuit for lighting control.

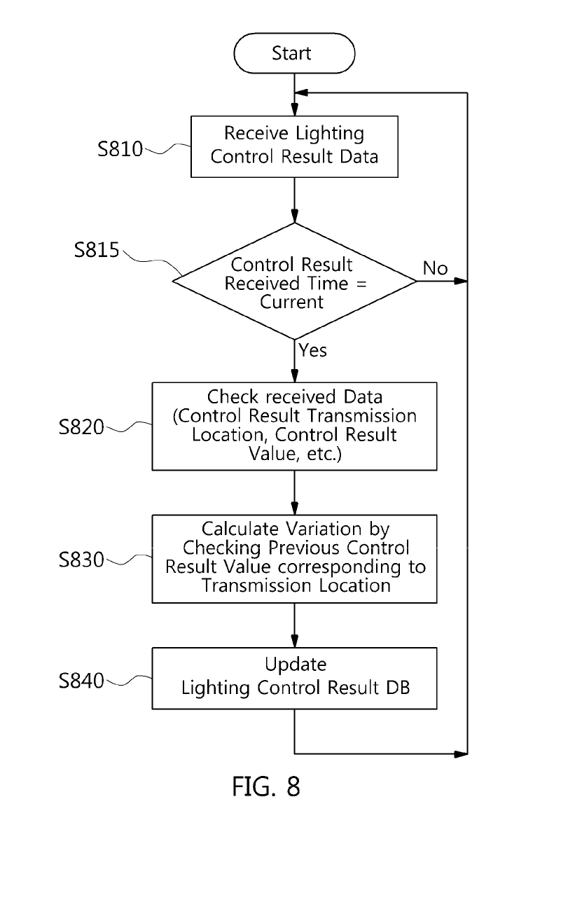

FIG. 8 is an operation flow chart illustrating a method for processing lighting control result data in accordance with an embodiment of the present invention.

With reference to FIG. 8, the lighting control result data processing method in accordance with an embodiment of the present invention starts with the integrated lighting control apparatus receiving the lighting control result data(S810). In this regard, the lighting control result is generated by integrating the lighting identification number and the control result information of the LED light source the brightness of which is controlled according to the power reserve stage-based lighting control information.

Next, control result received time in the received lighting control result data is compared with the current time (S815).

If the control result received time is determined to be not same as the current time by the comparison of Step (S815), the received lighting control result data is ignored.

When the comparison of Step (S815) indicates that the control result received time is same as the current time, the received lighting control result data is checked (S820).

Afterwards, it is possible to calculate variation by checking a transmission location from the lighting control result data, and the previous and current control result values of the respective transmission location are checked to calculate variation (S830).

The variation calculated at Step (S830) may be used to determine the power reserve stage in a subsequent step, and the lighting control result database may be updated with the lighting control result data (S840).

As mentioned above, the lighting control result database updated with the received lighting control result data is used to calculate variation by comparison between previous and updated control result values, thereby allowing for the effective determination of the power reserve stage.

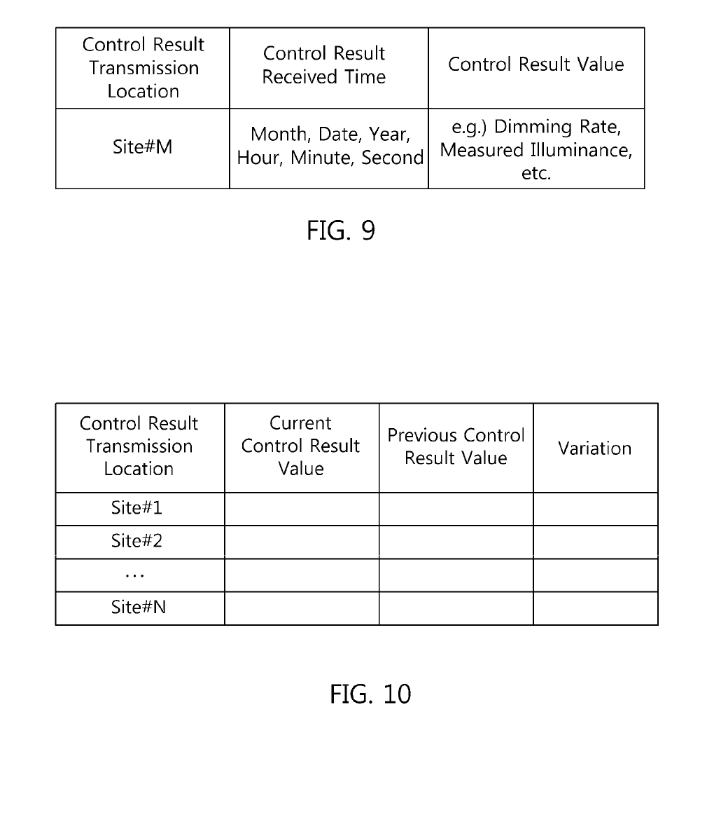

FIG. 9 is a table showing lighting control result data in accordance with an embodiment of the present invention.

With reference to FIG. 9, the lighting control result data in accordance with an embodiment of the present invention may include information on, for example, a control result transmission location, control result received time, a control result value, etc.

The control result transmission location may be acquired from information such as a lighting identification number of lighting controlled by the lighting controller.

The control result received time may correspond to a time at which the integrated lighting control apparatus receives the lighting control result data. The control result received time is compared with the current time either to check and process the lighting control result data if the control result received time and the current time are same, or to ignore the lighting control result data if the control result received time and the current time are not same.

The control result value may include information such as dimming rate or luminance, etc. by which a lighting equipment corresponding to the control result transmission location has been controlled.

FIG. 10 is a table showing lighting control result database in accordance with an embodiment of the present invention.

With reference to FIG. 10, the lighting control result database in accordance with an embodiment of the present invention may include information such as control a result transmission location, the current control result value, the previous control result value, variation, etc.

The control result transmission location can be acquired from information such as a lighting identification number of the lighting controlled by the lighting controller.

The current control result value refers to a control result value extracted from the most recently received lighting control result data, while the previous control result value refers to a control result value extracted from the lighting control result data at the same transmission location just before the most recently received lighting control result data has been received. In this case, if there is any lighting control result data received again at the same transmission location after the most recently received lighting control result data has been received, the current control result value may become the previous control result value, and a control result value extracted from the last received lighting control result data may become the current control result value.

For example, if lighting control result data was received at 1:00 p.m. and 3:00 p.m. of the day, respectively, from Site #1 transmission location, a control result value extracted from the lighting control result data received at 1:00 p.m. may become the previous control result value, while a control result value extracted from the lighting control result data received at 3:00 p.m. may become the current control result value. In addition, if lighting control result data has been received again at 5:00 p.m., a control result value extracted from the lighting control result data received at 5:00 p.m. may become the current control result value, the control result value extracted from the lighting control result data received at 3:00 p.m. may become the previous control result value, and the control result value extracted from the received lighting control result data received at 1:00 p.m. may be deleted.

The variation results from calculation of the change amount between current and previous control result values, and the database may be updated by calculating the change every time when new control result value is stored.

In accordance with the present invention, it is possible to provide information on the power reserve stages to the lighting controller to efficiently control the power to be used for lighting according to the power reserve stages.

In addition, the present invention enables effective power reserve control and power demand forecasting by providing power reserve stages in real time and receiving information on light control results according to the power reserve stages so as to enable integrated control of lighting.

In addition, the present invention is able to provide highly accurate power demand forecasting by enabling active automatic control of existing equipment settings, according to the power reserve stages, rather than allowing users or individual control systems to control lighting.

As described above, in the method and apparatus for integrally controlling lighting according to the present invention, the configurations and schemes in the above-described embodiments are not limitedly applied, and some or all of the above embodiments can be selectively combined and configured so that various modifications are possible.

What is claimed is:

1. An apparatus for integrated lighting control according to power reserve stage, comprising:
a lighting control result receiver for receiving lighting control result data generated by integrating a lighting identification number and control result information of the LED light source the brightness of which is controlled according to power reserve stage-based lighting control information;
a power reserve stage determination unit for determining a power reserve stage based on the received lighting control result data; and
a power reserve stage issuer for transmitting information on the determined power reserve stage to lighting controller in real time.

2. The apparatus of claim 1, wherein the power reserve stage issuer transmits the information on the power reserve stage every minimum allowable time span if the power reserve stage is lower than an alert stage, every medium allowable time span if the power reserve stage is between the alert stage and a stable stage, and every maximum allowable time span if the power reserve stage is higher than the stable stage.

3. The apparatus of claim 2, wherein the lighting control result data includes information on a control result transmission location, control result received time, and a control result value.

4. The apparatus of claim 3, wherein the lighting control result receiver compares the control result received time with the current time either to check the lighting control result data if the control result received time and the current time are same, or to ignore the lighting control result data if the control result received time and the current time are not same.

5. The apparatus of claim 4, further comprising a lighting control result database for storing and managing the lighting control result data.

6. The apparatus of claim 5, wherein the power reserve stage determination unit calculates variation of the control result value by checking a previous control result value received from the control result transmission location, and determines the power reserve stage based on the variation.

7. A power reserve stage-based lighting controller, comprising:
a power reserve stage receiver for receiving, in real time, information on the power reserve stage issued from an integrated lighting control apparatus;
a lighting soft switch unit for controlling brightness of an LED light source according to lighting control information corresponding to the information on the power reserve stage;
an LED lighting unit for transmitting a lighting identification number and control result information using the controlled brightness LED light source; and
a lighting control result transceiver for receiving the lighting identification number and control result information, integrating the lighting identification number and control result information to generate lighting control result data, and transmitting the lighting control result data to the integrated lighting control apparatus.

8. The power reserve stage-based lighting controller of claim 7, wherein the lighting controller performs lighting dimming control of the LED light source using the lighting soft switch unit if the power reserve stage is lower than an alert stage, and applies standby power to the lighting soft switch unit to prepare for a case where the power reserve stage becomes lower if the power reserve stage is in between the alert stage and a stable stage.

9. The power reserve stage-based lighting controller of claim 8, wherein the lighting control result transceiver transmits lighting dimming control information of the LED light source, in line with the lighting control result data, to the integrated lighting control apparatus if the power reserve stage is lower than the alert stage.

10. The power reserve stage-based lighting controller of claim 8, wherein the lighting controller does not apply standby power to the lighting soft switch unit if the power reserve stage is equal or higher than the stable stage.

11. A method for integrated lighting control according to power reserve stage, comprising:
receiving lighting control result data generated by integrating a lighting identification number and control result information of an LED light source the brightness of which is controlled according to power reserve stage-based lighting control information;
determining a power reserve stage based on the received lighting control result data; and
transmitting information on the determined power reserve stage to lighting controller in real time.

12. The method of claim 11, wherein the transmitting comprises transmitting the information on the power reserve stage every minimum allowable time span if the power reserve stage is lower than an alert stage, every medium allowable time span if the power reserve stage is between the alert stage and a stable stage, and every maximum allowable time span if the power reserve stage is higher than the stable stage.

13. The method of claim 12, wherein the lighting control result data includes information on a control result transmission location, control result received time, and a control result value.

14. The method of claim 13, wherein the receiving comprises comparing the control result received time with a current time either to check the lighting control result data if the control result received time and the current time are same, or to ignore the lighting control result data if the control result received time and the current time are not same.

15. The method of claim 14, further comprising storing and managing the lighting control result data.

16. The method of claim 15, wherein the determining comprises calculating variation of the control result value by checking the previous control result value received from the control result transmission location, and determining the power reserve stages based on the variation.

17. The method of claim 16, further comprising:
receiving, by the lighting controller, the information on the power reserve stage in real time to control brightness of a LED light source according to lighting control information corresponding to the information on the power reserve stage and transmitting, by the lighting controller, the lighting control result data generated by integrating the lighting identification number and the control result information received from the LED light source to the integrated lighting control apparatus.

18. The method of claim 17, further comprising:
performing, by the lighting controller, lighting dimming control of the LED light source using the lighting soft switch unit if the power reserve stage is lower than the alert stage and applying, by the lighting controller, standby power to the lighting soft switch unit to prepare for a case where the power reserve stage becomes lower if the power reserve stage is in between the alert stage and the stable stage.

19. The method of claim 18, further comprising:
transmitting, by the lighting controller, in line with the lighting control result data, lighting dimming control information of the LED light source to the integrated lighting control apparatus if the power reserve stage is lower than the alert stage.

20. The method of claim 18, further comprising:
Not applying, by the lighting controller, standby power to the lighting soft switch unit if the power reserve stage is equal or higher than the stable stage.
